(19) United States
(12) Patent Application Publication
(10) Pub. No.: US 2006/0277074 A1
(43) Pub. Date: Dec. 7, 2006

(54) Rehabilitation methods

(75) Inventors: Omer Einav, Kfar-Monash (IL); Haim Einav, Tel-Aviv (IL); Ester Zohar, Givataym (IL)

Correspondence Address: WOLF, BLOCK, SCHORR & SOLIS-COHEN LLP, 250 PARK AVENUE, NEW YORK, NY, 10177, US

(73) Assignee: Motorika, Inc., Road Town (VG)

(21) Appl. No.: 11/348,128

(22) Filed: Feb. 6, 2006

Related U.S. Application Data
(63) Continuation-in-part of application No. PCT/IL05/00142, filed on Feb. 4, 2005.
(63) Continuation-in-part of application No. PCT/IL05/01318, filed on Dec. 7, 2005.
(63) Continuation-in-part of application No. 11/207,655, filed on Aug. 18, 2005.
(60) Provisional application No. 60/709,747, filed on Aug. 18, 2005.
(60) Provisional application No. 60/633,442, filed on Dec. 7, 2004.
(60) Provisional application No. 60/665,886, filed on Mar. 28, 2005.

(51) Int. Cl. G06F 19/00

(52) U.S. Cl. 705/3

(57) ABSTRACT

A computerized clinic management system. The system includes a database of patient records and a database of clinic resources reflecting a temporal availability of each individual resource in the database of clinic resources. The system optionally also includes and a scheduling module designed and configured to determine an initial subset of clinic resources required for an initial treatment plan for a patient based upon analysis of the database of patient records and to determine an initial schedule of therapy for said patient based upon further analysis of temporal availability of the subset of said clinic resources.

### RELATED APPLICATIONS

This application is continuation-in-part of the following applications: PCT/IL2005/000142 entitled “Methods and Apparatus for Rehabilitation and Training filed Feb. 4, 2005, and PCT/IL2005/001318 entitled “Device and Method for Training, Rehabilitation and/or Support” filed Dec. 7, 2005. This application is also a continuation-in-part of U.S. application Ser. No. 11/207,655 entitled “Methods and Apparatuses for Rehabilitation and Training” filed on Aug. 18, 2005. The disclosures of all these applications are incorporated herein by reference.

This application also claims the benefit under 119(e) of the following U.S. Provisional Applications: 60/709,747 filed Aug. 18, 2005, 60/633,442 filed on Dec. 7, 2004 entitled “Methods and Apparatus for Rehabilitation and Training”; 60/665,886 filed on Mar. 28, 2005 entitled “Device and Method for Training, Rehabilitation and/or Support”; 60/735,447 filed on Nov. 10, 2005 entitled “Device and Method for Training, Rehabilitation and/or Support”, 60/542,022 entitled Methods and Apparatus for Rehabilitation and Training filed Feb. 5, 2004 the disclosures of all these applications are incorporated herein by reference.

### FIELD OF THE INVENTION

The present invention relates to rehabilitation methods, for example, to organizing of workflow in a clinic.

### BACKGROUND OF THE INVENTION

After stroke, it is generally desirable to perform a massive rehabilitation effort, to prevent any residual functions from being lost and/or bad habits taken up by the patient. A common way of providing such rehabilitation is by inviting a patient for several hours of rehabilitation, several times a week. Unfortunately, partly due to lack of sufficient man power, a patient may spend as much as 1.5 or more hours waiting for a rehabilitation session. This is generally demoralizing to the patient.

### SUMMARY OF THE INVENTION

An aspect of some embodiments of the invention relates to making more efficient use of a patient's time in a rehabilitation clinic.

In an exemplary embodiment of the invention, rehabilitation is organized to reduce wastage of time of the patient. In one example, waiting time is reduced. In another example, exercises are reorganized in time to make more efficient use of the patient's time and/or rest periods. Optionally, overhead times associated with rehabilitation, such as set up and leaving a machine and/or instructions, are reduced and/or made into rehabilitation time.

In an exemplary embodiment of the invention, the rehabilitation is organized to reduce wastage of machine time. Optionally, the machines are designed to be multi-purpose so that for any given machine there is a wider range of rehabilitation exercises that can be carried out. Optionally, the machines are configured with attachments which are used to modify the function of the machine. Optionally, the machines are configured so that a first patient can be replaced with a second patient during a resting period of the first patient. Some reorganizing of the exercise schedule may be provided as well.

In an exemplary embodiment of the invention, rapid personalization, attachment and/or detachment of a patient to a machine are provided. Optionally, personalized attachments are pre-attached to a patient so that the patient can be snap-connected to the machine.

In an exemplary embodiment of the invention, rehabilitation tasks are broken down and reorganized so that tasks currently carried out by expert therapists are carried out by machines and/or less skilled personal and/or avoided. For example, setting up of a patient in a machine is optionally carried out by an unskilled person and by the machine. In another example, a patient is moved between stations automatically or with an indication to an unskilled person. In another example, a patient wheelchair is used for rehabilitation so no set-up is required.

Optionally, a wireless or contact memory device is used to notify the machine of a patient that arrived and to set up the machine properly. Optionally, the machine adjusts one or more moving parts thereof to a starting position at which patient attachment is simplified.

In an exemplary embodiment of the invention, the rehabilitation machines and/or patient chairs and/or patient communicator devices which may be associated with the patients include an indication of a next available patient to be attached to a machine and/or a machine available for patient use.

An aspect of some embodiments of the invention relates to a clinic design which takes into account the use of certain types of rehabilitation systems, such as patient moving rehabilitation devices, personal rehabilitation systems and/or multi-purpose rehabilitation devices. Optionally, the clinic design includes robotic elements.

In an exemplary embodiment of the invention, a clinic includes a plurality of empty rooms which may include a limited amount of machinery and which may serve for any available patient with their rehabilitation device. Optionally, the rehabilitation device is pre-attached to the patient and is brought into the room with the patient or the device brings in the patient. Alternatively, they may be brought separately. Optionally, the rehabilitation device is portable in case a different room is desirable, for example a room with different sensing systems and/or entertainment systems. Optionally, portable devices may be used outside the clinic.

In an exemplary embodiment of the invention, the clinic includes, near a patient reception area, a stable of carts to which a patient can be attached as soon as they check in. Optionally, the carts provide rehabilitation functions. Alternatively or additionally, the carts automatically move the patient between rehabilitation stations. Optionally, the carts can connect into a rehabilitation station, minimizing the need to get in and/or out of a cart. Optionally, the carts include indicators to caretakers showing where a next station is.

Optionally, the cart can be a robot, for example one with features of a living creature, such as for example, a voice. According to various embodiments of the invention the robot may be recognizably android or canine, feline, bovine, equine, porcine or be made to resemble any other animal(s). Optionally, at least a portion of the robot is configured to accompany the patient outside the clinic, for example to their home. According to various embodiments of the invention, the robot may engage in a behavior designed to elicit a response from the patient.

Optionally, patients treated in the clinic may be suffering from, for example, CNS damage, peripheral nervous system damage, trauma, non traumatic muscle degeneration or obesity. CNS damage includes, but is not limited to damage caused by cerebral hemorrhage (e.g. stroke), cerebral palsy (CP), spinal cord injury, multiple sclerosis (MS) or Myasthenia gravis (MG). Peripheral nervous system damage may result, for example from burns or exposure to toxins. Trauma may include, but is not limited to, injuries such as automobile accident related injuries, gunshot wounds, knife wounds, sports injuries, blunt force trauma and repetitive stress disorder (e.g. carpal tunnel syndrome). Non traumatic muscle degeneration may include, but is not limited to, muscular dystrophy (MD) or polio. Obesity may require rehabilitation even if no other medical diagnosis is operative. Optionally, therapy is prophylactic therapy designed to insure that therapy subjects with no specific medical problem remain in good physical condition. Optionally therapy is palliative and aims to slow the rate of functional incapacitation associated with a degenerative disorder such as MS or MD.

Optionally, seemingly trivial activities are incorporated by the operating system into one or more therapeutic goals in accord with an individual patient treatment plan. Alternatively or additionally, reduction or elimination of time between administration of various therapies is attempted, for example by having a single patient perform a wide range of therapies in a single device or machine. Optionally, at least 60%, or a least 70%, or at least 80%, or at least 90% or virtually all of the time a patient spends in the clinic is therapeutic.

Optionally, an operating system of the clinic includes one or more translation modules to permit data input and/or output in a variety of languages.

In an exemplary embodiment of the invention, a computerized clinic management system is provided. The system includes:

(a) a database of patient records;

(b) a database of clinic resources reflecting a temporal availability of each individual resource in the database of clinic resources; and

(c) a scheduling module, the scheduling module designed and configured to determine an initial subset of the clinic resources required for an initial treatment plan for a patient based upon analysis of the database of patient records and to determine an initial schedule of therapy for the patient based upon further analysis of the temporal availability of the subset of the clinic resources.

Optionally, the system further includes a plurality of communication modules, each individual module of the plurality of communication modules assigned to a specific clinic resource and designed and configured to apprise the database of clinic resources regarding an actual availability status of the specific clinic resource.

Optionally, the system further includes a plurality of communication modules, each individual module of the plurality of communication modules assigned to a specific clinic resource and designed and configured to apprise the database of clinic resources regarding a location of the specific clinic resource.

Optionally, the system further includes a plurality of communication modules, each individual module of the plurality of communication modules assigned to a specific patient and designed and configured to apprise the database of patient records regarding an occupation status of the specific patient.

Optionally, the system further includes a plurality of communication modules, each individual module of the plurality of communication modules assigned to a specific patient and designed and configured to apprise the database of patient records regarding a location of the specific patient.

Optionally, the system further includes a plurality of communication modules, each individual module of the plurality of communication modules assigned to a specific patient and designed and configured to apprise the database of patient records regarding a performance statistic of the specific patient with regard to at least a portion of the treatment plan.

Optionally, at least a portion of the clinic resources include a programmable robotic component.

Optionally, the system further includes a billing module, the billing module designed and configured to detect use of the subset of the clinic resources by a patient and to issue a bill according to a billing designation in the database of patient records.

Optionally, the system further includes a plurality of communication modules, each of the communication modules associated with a clinic resource and capable of reporting at least an availability status of the clinic resource to the database of clinic resources.

Optionally, at least some of the communication modules are additionally capable of reporting a patient performance statistic to the database of patient records.

Optionally, the system further includes a diagnostic module, the diagnostic module designed and configured to suggest changes in the initial treatment plan based upon the patient performance statistic to produce a revised treatment plan.

Optionally, the revised treatment plan is subject to review by a human prior to implementation thereof.

Optionally, the revised treatment plan causes the scheduling module to determine a revised subset of the clinic resources and to determine a revised schedule of therapy. In an exemplary embodiment of the invention, a modular therapy clinic is provided. The clinic includes:

(a) a plurality of multipurpose locations; and

(b) a plurality of portable therapy devices;

(c) a scheduling module, the scheduling module designed and configured to determine a schedule of therapy device placement based upon anticipated need.

Optionally, the clinic includes at least one non-portable therapy device located in at least one of the locations.

In an exemplary embodiment of the invention, a method for calculating a fee for a rehabilitation service is provided. The method includes:

(a) receiving a data input indicative of a number of temporal units during which a patient was engaged in interaction with a therapeutic device;

(b) multiplying the number of temporal units by a billing rate of the therapeutic device to produce the calculated fee as a product.

In an exemplary embodiment of the invention, a method for calculating a fee for a rehabilitation service is provided. The method includes:

(a) receiving a data input indicative of a number of connection events during which a patient was connected to a therapeutic device;

(b) multiplying the number of connection events by a billing rate of the therapeutic device to produce the calculated fee as a product.

In an exemplary embodiment of the invention, a method of cognitive rehabilitation therapy is provided. The method includes:

(a) permitting a patient to navigate a path from an origin to a destination in an environment; and

(b) employing a computerized system to track the patient's position and compare the patient's position to the path and generate a comparison indicator.

Optionally, the method includes further employing the computerized system to provide at least one correction cue if the comparison indicator exceeds a defined limit.

Optionally, the method includes providing a set of navigation instructions to the patient.

Optionally, the method includes regulating a navigational parameter of the patient.

Optionally, the patient navigates a device along the path.

Optionally, the patient rides on the device.

In an exemplary embodiment of the invention, a computer controlled cognition therapy device is provided. The device includes

(a) a navigable cart; and

(b) a computerized navigation component operative to track the cart's position and compare the cart's position to a target path and generate a comparison indicator.

Optionally, the device includes a cue provision module operative to provide at least one correction cue if the comparison indicator exceeds a defined limit.

Optionally, the device includes an instruction module operative to provide a set of navigation instructions to an operator of the device.

Optionally, the device includes a regulatory mechanism operable to regulate a navigational parameter of the cart.

Optionally, the device is configured so that an operator of the cart may ride the cart.

In an exemplary embodiment of the invention, a method of increasing efficiency of rehabilitation of a plurality of patients is provided. The method includes:

(a) providing a plurality of resources, each of the resources capable of communication with a computerized controller for purposes of informing the controller of an actual availability status;

(b) permitting the computerized controller to assign each individual patient belonging to the plurality of patients to at least one of the resources based upon the actual availability status without regard to a fixed time schedule.

Optionally, the assigning is done with consideration of an individual therapy plan for each individual patient belonging to the plurality of patients.

### BRIEF DESCRIPTION OF THE FIGURES

The present invention will be more clearly understood from the following description of embodiments thereof read with reference to figures attached thereto. In the figures, identical structures, elements or parts that appear in more than one figure are generally labeled with the same numeral in all the figures in which they appear. Dimensions of components and features shown in the figures are chosen for convenience and clarity of presentation and are not necessarily shown to scale. The figures are listed below.

FIG. 1 is an organizational hierarchy of an exemplary embodiment of a rehabilitation clinic according to the present invention;

FIG. 2 is a floor plan of an exemplary embodiment of a rehabilitation clinic according to the present invention;

FIG. 3 is a perspective view of an exemplary embodiment of a robotic chair cart and optionally detachable exercise module according to the present invention;

FIG. 4 is a perspective view of an additional exemplary embodiment of a robotic chair according to the present invention with exemplary functional features exposed;

FIG. 5 is perspective view of an additional exemplary embodiment of a robotic cart according to the present invention; and

FIG. 6 is a perspective view of an exemplary rehabilitation device suitable for use in the context of some embodiments of the present invention.

### DETAILED DESCRIPTION OF EXEMPLARY EMBODIMENTS

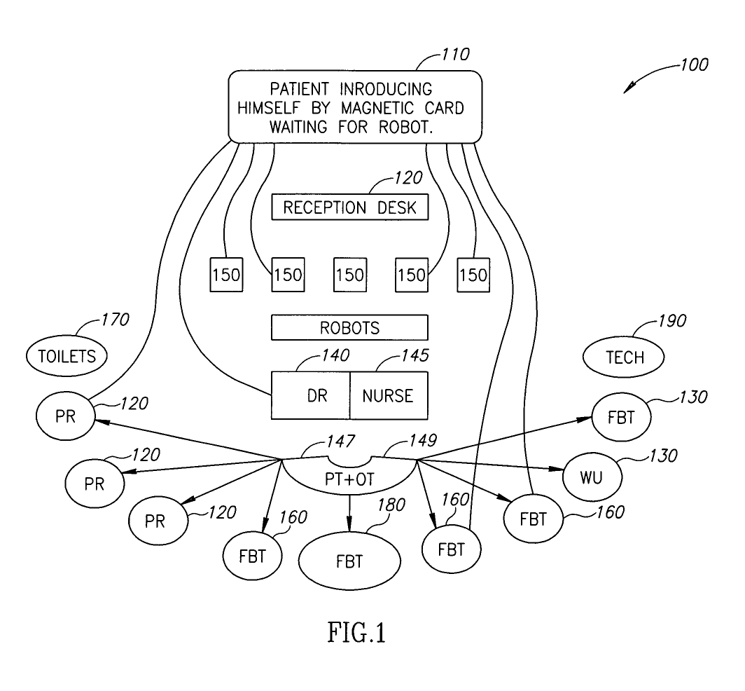

According to an exemplary embodiment of the invention (FIG. 1), an organizational hierarchy of an exemplary embodiment of a rehabilitation clinic 100 according to the present invention is presented. One or more patients 110 enter clinic 100 and proceed to reception area 120 which is optionally an unmanned station. Each of patients 110 identifies themselves to the operating system 190 of clinic 100 through an interface at reception area 120. Optionally, this is done by patient input of a unique identifier through an input device. Operating system 190 of clinic 100 may reside, for example in a computerized server stored in technical room 290.

The unique identifier may be, for example, a physical characteristic, an identification number, a machine readable key or a broadcast signal.

The input device may be, for example, a fingerprint reader, a retinal scanner, a keyboard, a touch-screen, a microphone, a bar code reader, a magnetic card reader or a receiver (e.g. radio, infrared or microwave receiver or cellular telephone).

For example, a patient 110 may visit clinic 100 for the first time and enter a unique alphanumeric identifier (e.g. Social Security number or insurance carrier patient number or cellular telephone number) into the computer system by means of a touch screen or voice activated computer station in reception area 120. Alternatively or additionally, a patient places a call from their cellular telephone to a designated “check-in” number as a means of announcing their arrival. Optionally, a human attendant will be available to assist those patients 110 that have difficulty with the check in procedure. Optionally, assistance may mean performing the check-in for the patient. Optionally, patient 110 enters additional data, for example in response to questions presented on a display screen. Optionally, additional demographic and diagnostic data is already in the system and is associated with the unique alphanumeric identifier. Optionally, patient 110 is issued with a clinic pass for use in subsequent visits. This clinic pass may be, for example a magnetic card or an RF transceiver. The RF transceiver may optionally be equipped with a data storage device such as, for example, a flash memory card. The clinic pass streamlines the check-in process for subsequent visits by allowing the operating system to detect a patient's presence and/or position.

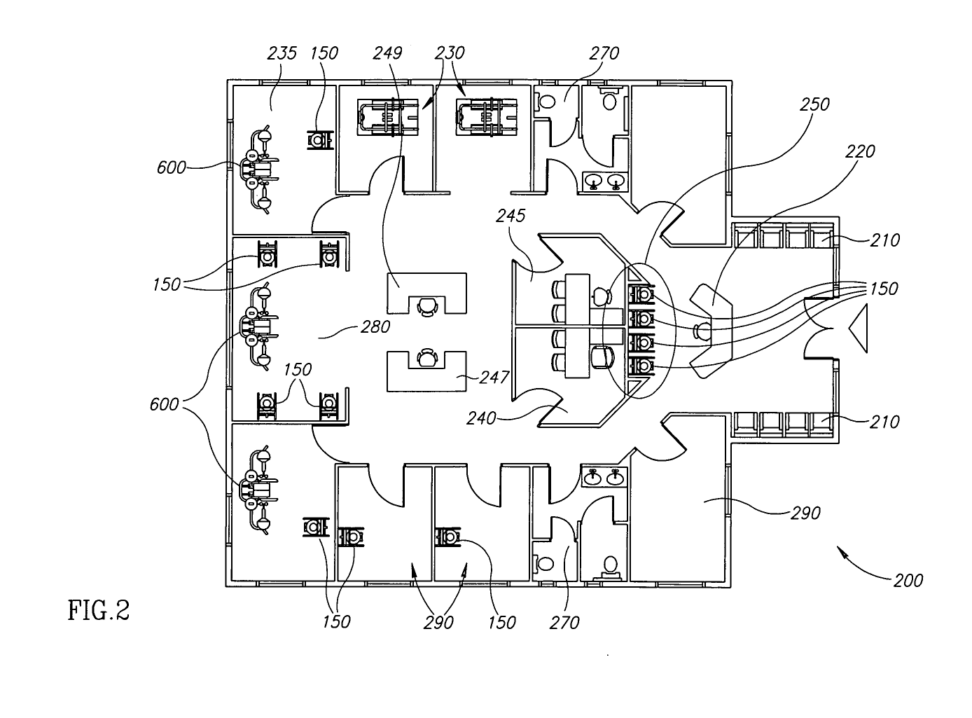

Referring now to FIG. 2, a floor plan 200 of clinic 100 illustrates a waiting area 210 for a plurality of patients. Waiting area 210 is optionally smaller than required for a conventional clinic because of the efficiency with which clinic 100 operates. This optionally results in savings associated with reduced operational costs in the form of infrastructure costs. A plurality of robotic carts 150 are stationed in a cart queue 250 adjacent to waiting area 250. Patients 110 may optionally check in at registration desk 220 as detailed hereinabove. Optionally, patients 110 are equipped with transmitters (e.g. RF or Infrared) which announce their arrival to reception area 220, which summons a robot 150 from robot queue for them. The robot 150 is informed of relevant patient data (e.g. patient name) by the operating system 190 of clinic 100 and may, for example greet patient 110, addressing the patient by name. In an exemplary embodiment of the invention, operating system 190 of the clinic includes one or more translation modules to permit data input and/or output in a variety of languages. Using this optional module, a robotic device 150 may, for example, address a new patient in their mother tongue (e.g. Russian or Japanese). Optionally, robotic device 150 is additionally capable of receiving and/or translating and/or relaying verbal inputs from the patient in their mother tongue to system 100. As a result, patient 110 may perceive clinic 100 as operating in their mother tongue, although it is actually operating in another language (e.g. English). This optional feature may be especially important in the context of elderly patients and/or stroke victims and/or head trauma patients that may have reverted to their mother tongue. Alternatively or additionally, this optional feature may allow clinic 100 to provide improved service to one or more immigrant populations. Alternatively or additionally, this optional feature reduces a need for translators on the staff of clinic 100.

The operating system 190 of clinic 100 receives a treatment plan from medical personnel (e.g. doctors 140 and nurses 145) and/or paramedical personnel (e.g. physical therapist 147 and occupational therapist 149). These personnel are optionally present in clinic 100 in doctors' station 240, nurses' station 245 physical therapist station 247 and occupational therapist station 249. Alternatively or additionally, personnel in these categories may work off-site. The treatment plan optionally includes one or more therapy regimens, including patient specific instructions. The therapy regimens may include, but are not limited to, one or more of walking or gait related exercises 130, administered in walking unit 230 full, body treatment 160 administered in a full body unit 600. Additional therapy regimens may include, but are not limited to, speech therapy exercises, cognitive exercises, hand/eye co-ordination exercises and manual dexterity and/or grip strength exercises. Optionally, clinic 100 does not require fixed definitions of treatment areas, and a single room may be used for different types of treatment depending upon the equipment located in the room at a given time. Optionally, a patient enters an empty room with robot 150 and performs treatment with the robot and/or attachable modules. Optionally additional therapy equipment is present in the room. Optionally, the additional therapy equipment is permanently installed in the room. In an exemplary embodiment of the invention, robot 150 includes all required equipment for a specific patient 110 and physical transfer from one treatment room to another becomes superfluous. Optionally robot 150 accompanies and/or assists patient 110 to non-therapeutic locations such as rest room/locker room 170. In an exemplary embodiment of the invention, daily activity rehabilitation 180 may be offered in a daily activities room 280 equipped, for example with a kitchen including a stove, sink and refrigerator. Alternatively or additionally, daily activities room 280 may be equipped with a writing/eating table and/or a computer and keyboard. Daily activities room 280 may be employed for rehabilitation of patients with physical limitations and/or cognitive limitations. Alternately or additionally, robots 150 may accompany patients 110 outside of clinic 100, for example to public areas and/or to their homes. This permits therapy to continue outside of clinic 100. Optionally, clinic 100 permits one or more of doctors 140, nurses 145, physical therapist 147 and occupational therapist 149 to monitor patient 110 either during therapy or between therapy session. These medical and paramedical personnel may have access to various types of data according to various embodiments of the invention. For example, medical personnel may be able to view video images of patient 110 performing therapy exercises. Optionally, relevant physiologic data (e.g. ECG plot or O₂ saturation) is concurrently displayed. Optionally, medical personnel may be able to review summary reports, for example reports that indicate patient performance in terms of progress towards defined goals. This review may be conducted, for example during consultation between medical personnel and patients, by a single clinic staff member reviewing an individual patient file, or by multiple staff members conducting rounds. Since patient summary reports are computerized, clinic staff may optionally conduct “virtual rounds” in which multiple cases are reviewed while patients are not physically present. Optionally, virtually rounds may be conducted while participants are in multiple physical locations, for example, by video conference or teleconference. This possibility is useful, for example, in clinics 100 which operate primarily on an outpatient bases.

In order to more fully understand the operational flexibility of clinic 100, an illustrative example of a fictitious patient 110 is provided in some detail. This example is provided should not be construed to limit the invention. A patient 110 named Leonard Smith has been referred to clinic 100 by his primary care physician after initial hospitalization following a stroke. Optionally, Mr. Smith may have had some conventional rehabilitation in the hospital. Optionally, Mr. Smith may become a patient of clinic 100 while he is an inpatient at the hospital. In order to allow this possibility, clinic 100 may be located within, or adjacent to, a hospital. Alternatively or additionally, clinic 100 may practice “robotic outreach” in which some clinic resources are brought to hospital inpatients. The term “hospital” as used in this context may optionally include any inpatient care facility. Mr. Smith is 61 years old and was in reasonable physical condition prior to his stroke. He was accustomed to bowling in a weekly league and playing bridge with his wife and another couple. He was ranked as an “expert” bridge player prior to his stroke. His primary care physician has indicated that Mr. Smith is suffering from physical impairment in the form of partial paralysis on his left side. His left arm/hand, left leg/foot and left half of his face are affected. In addition Mr. Smith suffers from aphasia and has difficulty with short term memory. Although Mr. Smith is right handed, he is unable to dress himself and attend to personal hygiene because of a combination of physical and cognitive impairments. In addition, his speech is impaired by paralysis of the left side of his mouth. Mr. Smith is on sick leave from his job as logistics coordinator in a manufacturing firm. Mr. Smith and his wife have both indicated that they are interested that Mr. Smith should live at home during rehabilitation. All of this information has been gathered by the primary care physician and is available in a database of the operating system 190 of clinic 100 together with Mr. Smith's insurance number.

Mrs. Smith accompanies Mr. Smith 110 on his initial visit to clinic 100. Mr. Smith is in a wheelchair pushed by Mrs. Smith at this point. They proceed to waiting area 210 where Mrs. Smith positions the wheelchair in a corner and engages the brakes. Mrs. Smith proceeds to reception area 220 and interacts with reception interface 120 by swiping a magnetic card provided by the insurance carrier through a card reader. This action provides Mr. Smith's unique identifier in the form of an insurance carrier customer ID number to the operating system 190 of clinic 100. Any services provided by clinic 100 to Mr. Smith 110 will be billed to the insurance company after this point. Reception interface 120 optionally prepares a patient ID bracelet 530 for Mr. Smith. The bracelet is optionally a communication module 530 which optionally includes an RF transmitter to facilitate communication with the operating system 190 of clinic 100. Alternatively or additionally, the bracelet 530 includes a data storage component to accumulate data concerning physiologic parameters (e.g. pulse rate, temperature or dermal conductance). This physiologic data may be relayed to robot 150 and/or to the operating system 190 of clinic 100. Optionally, the bracelet 530 is configured as a wristwatch so that Mr. Smith will feel comfortable wearing it outside of clinic 100. Bracelet communication module 530 makes the operating system 190 of clinic 100 aware of Mr. Smith's location by transmitting a signal.

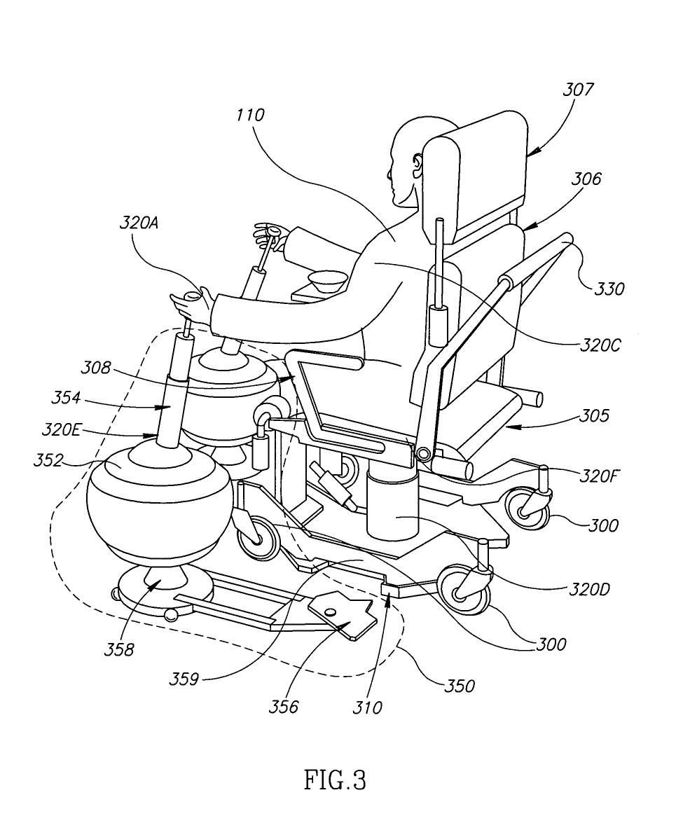

Reception module 120 summons a robot 150 from robot queue 250. Optionally, robot 150 is equipped with a communication module 530. Concurrently, reception module 120 programs robot 150 with at least a portion of Mr. Smith's current treatment plan. Robot 150 accompanies Mrs. Smith to waiting area 210 where Mr. Smith places the bracelet 530 on his left hand. The operating system 190 of clinic 100 has been apprised of Mr. Smith's diagnosis, specifically that his current status is non-ambulatory. For this reason, reception module 120 has summoned a chair type robot 150 (e.g. of the type shown in FIG. 3) from queue 250. Robotic chair 150 may include basic elements, for example a seat 305, a backrest 306 and/or a headrest 307 to provide basic physical support for patient 110.

Alternatively or additionally, reception module 120 has also summoned a human attendant to assist in transferring Mr. Smith from his wheelchair to chair type robot 150. Robot 150 introduces itself to Mr. Smith using voice simulation software and a speaker. Mrs. Smith is dismissed at this point. Optionally she will not be required to accompany Mr. Smith on subsequent visits to clinic 100. Optionally she will accompany Mr. Smith on subsequent visits to clinic 100, for example if robot 150 does not function as a wheelchair. Optionally she can perform helping tasks (e.g. instead of a PT assistant) as assigned to her by the operating system. Optionally, this may reduce billings to Mr. Smith's insurance carrier. Optionally, Mrs. Smith is assigned a communication module 530 for this purpose. Alternatively or additionally, system 190 communicates with Mrs. Smith through her cell phone, for example via text messages. Optionally this permits Mrs. Smith to remain aware of and/or manage Mr. Smith's appointments at clinic 100.

Optionally, the equipment issued to Mr. Smith is not a robot, but a conventional wheelchair which includes an interface to one or more therapy workstations located throughout clinic 100. Optionally, some of these work stations may be robotic devices 150. In an exemplary embodiment of the invention, the equipment issued to Mr. Smith includes at least one input device which requires active manipulation by Mr. Smith. The input device includes one or more sensors to measure one or more input parameters such as, for example, grip strength, magnitude of applied force and direction of applied force. This permits the device to monitor Mr. Smith and provide feedback to operating system 190. Optionally, the device includes a controllable resistance feature so that the difficulty of any exercise may be changed.

In an exemplary embodiment of the invention, robotic device 150 runs on rechargeable batteries. These batteries may be charged, for example, when chair type robot 150 is connected to an external therapy device. Alternatively or additionally, chair type robot 150 may have one or more exercise modules 350 attached. These modules 350 may be of the pictured “ball and stick” type or of any other type, for example articulated arms or flexible springs.

Robot 150 communicates freely with the operating system 190 of clinic 100, for example over a wireless intranet. The operating system 190 monitors availability of resources in clinic 100 including human staff and robotic or mechanical resources including treatment rooms. Additionally, the operating system 190 has access to the treatment plan of each patient 110 in clinic 100. The operating system 190 compares available resources to treatment plans and patient presence and allocates resources among patients 110 on an ongoing basis. This allocation may be accomplished using any resource method known in the art. Optionally, the operating system 190 also considers patient reaction to a specific therapy exercise when making resource allocation decisions. For example if physiologic data received from Mr. Smith's bracelet 530 indicates that he is becoming fatigued after fourteen minutes of physical therapy exercises on his left leg, the operating system 190 may route Mr. Smith to a cognitive exercise designed to help him overcome his aphasia. This provides a physical rest without producing a cessation in therapy delivery. Alternately, Mr. Smith may be allowed a brief rest from all forms of therapy. Concurrently, the operating system 190 may route another patient 110 to the machine Mr. Smith is vacating in a therapy room 230. As a result, in some exemplary embodiments of the invention, patients 110 are guided through a series of therapy exercises in different therapeutic realms (e.g. physical therapy, occupational therapy, daily living activities, speech therapy and cognitive exercises) with waiting times that are shorter than those experienced in a conventional rehabilitation center. In an exemplary embodiment of the invention, Mr. Smith does not perceive any waiting in excess of one minute during a visit to clinic 100. Concurrently, the resources of clinic 100, whether robotic or human, are employed with reduced waiting time between tasks. Because each of patients 110 is closely monitored by the operating system 190 of clinic 100, it is possible to bill for services in small increments. Billing may be, for example, based upon temporal units (e.g. hours, minutes or fractions thereof) and/or connection events to specific robots, devices or modules. This affords clinic 100 greater flexibility in implementation of a treatment plan. In an exemplary embodiment of clinic 100, skilled human staff members devote most of their workday to the tasks in their area of expertise, especially those which require thought and analysis. In an exemplary embodiment of clinic 100, human staff members with lower skill levels devote most of their workday to simple tasks, especially those which require little thought or analysis (e.g. moving patients from room to room) or connecting/disconnecting modules 350 and robots 150.

For example, in a conventional rehabilitation center, a patient 110 might be scheduled for physical therapy at 10:00 AM and occupational therapy at 11:00 AM. If the patient complained of leg cramps at 10:15, the physical therapy session might be cut short but the insurance provider would still be billed for a full clinical hour of physical therapy because the physical therapist had been allocated to a specific patient for that block of time. The patient in the conventional rehabilitation center would still need to wait forty five minutes for a scheduled turn with the occupational therapist. As a result, a conventional clinic may require insurance carriers to pay fees for services which were never actually provided.

In an exemplary robotic clinic 100, a patient checking in at 10:00 would be allocated to an available resource that matched their treatment plan. If they began physical therapy at 10:00 and complained of leg cramps at 10:15, the therapy session might be cut short. However, the operating system 190 of clinic 100 would bill the insurance provider only for resources actually used. Resources which became available as a result of the short physical therapy session would be allocated to another patient within a short period of time. Alternatively or additionally, patient 110 would be quickly assigned to alternate resources to address another portion of their therapy plan. As a result, the percentage of time that each available resource in the clinic is in actual use is increased. This can contribute to increased total billings for clinic 100. Concurrently, patient 110 perceives less waiting time during a visit to clinic 100 and may be more likely to describe a visit as “useful” or “beneficial”.

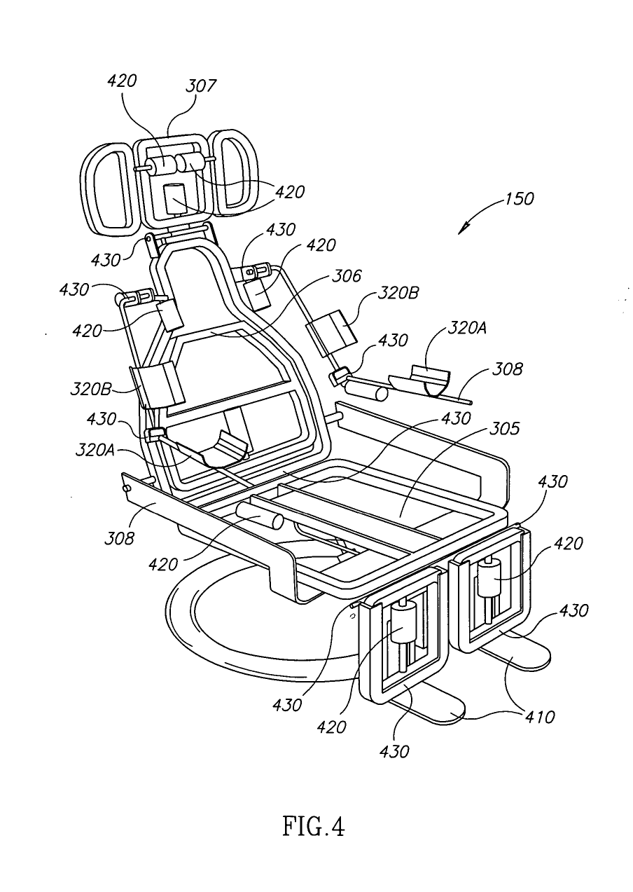

Returning now to Mr. Smith, because his physical impairment is restricted to his left side, his individual treatment plan includes a series of exercises designed to help him reacquire sensory and motor neuronal function in the affected portions of his body on the left side. Optionally, issues of muscle strength may also be addressed if atrophy has occurred. In order to provide an interface with robotic components 150 of clinic 100, Mr. Smith is optionally fitted with a series of attachment bands 320 (FIG. 4). This may optionally be accomplished by a custom fitting procedure, for example one in which casts or molds of relevant body parts are prepared. Optionally, an orthotist moves a target body part to a desired position and applies plaster to form a cast which serves as a mold. Optionally ink is applied to the skin to produce marks indicating anatomic features on an inner surface of the mold. After the cast sets, the mold is peeled away and filled with additional plaster to make an anatomical model. Band fitting may optionally be on the model. Optionally, operating system 190 indicates desired attachment points on the model. Optionally the orthotist and/or physical therapist and/or physician make this decision.

In an exemplary embodiment of the invention, bands 320 for patients may be stored in an organized manner in storage room 202. Bands 320 can optionally be employed to force patient compliance with a desired motion by preventing fixing a body part to prevent an undesired motion that would reduce efficacy of an exercise. Optionally, a single band 320 may be fitted with multiple attachments which may be applied serially and/or concurrently.

For example (FIG. 3), Mr. Smith might be fitted with attachment bands 320A (FIG. 4) at his left wrist, 320B (FIG. 4) slightly above his left elbow, 320C slightly below his left shoulder, 320D slightly above his left knee and 320E slightly above his left ankle. Optionally, he might also be fitted with an attachment band 320F in the form of a belt to all allow positioning of his left hip. Each attachment band 320 is attachable to one or more robotic devices 150 and/or therapy modules 350 using one or more attachment points. Robotic devices 150 and/or therapy modules 350 may apply extension and/or angular rotation to a selected muscle group, joint or body part by moving one or more attachment bands 320. Optionally, attachment bands 320 are equipped with position sensors which can relay positional information to the operating system 190 of clinic 100, for example through the patient bracelet 530 or through one of robotic devices 150. Optionally, the attachment bands are attached and/or adjusted by a human staff member of clinic 100. Optionally, the attachment bands are attached and/or adjusted by a robotic device 150 using one or more position sensors optionally installed on robotic device 150 and/or attachment bands 320. Optionally attachment is fast and easy. Fast and easy attachment may be achieved, for example, by use of electromagnets controlled by operating system 190. Alternatively or additionally, fast and easy attachment may be achieved, for example, by use of push and click attachment devices (e.g. snaps or buckles).

Because Mr. Smith is currently non ambulatory he rides his robotic device 150 in the form of a chair with wheels 300. Wheels 300 are optionally motor-driven. Optionally, a human attendant (e.g. clinic employee or family member) guides robotic chair 150 by means of a handle 330. Optionally, Mr. Smith steers and navigates, for example by operating a joystick with his right hand. Optionally the operating system 190 of clinic 100 issues instructions to Mr. Smith and/or the attendant, for example by having robotic device 150 speak through a communication module (not pictured). Instructions may be issued, for example, if Mr. Smith deviates from a desired path determined by system 190. Optionally, operating system 190 limits speed and/or direction of individual patients 110 based upon a current functional status indicated in a patient record in a database in order to prevent patient injury and/or damage to clinic 100. These limitations may be imposed, for example, by a system override of a motorized drive of wheels 300 on robotic cart 150. Alternatively or additionally, a governor may be installed on the motor.

In an exemplary embodiment of the invention, Mr. Smith employs robotic chair 150 to compensate for the physical limitations of his left leg. Concurrently, navigation through clinic 100 serves as cognitive rehabilitation for Mr. Smith. Optionally, Mr. Smith might begin navigational training with a simple exercises, such as steering around an oval track in a large, optionally empty room. Optionally, the operating system 190 of clinic 100 drives and navigates robotic chair 150 through clinic 100. This may be accomplished, for example, by equipping robotic chair 150 with one or more sensors to follow guides that can be in floor, ceiling or walls. One example is a wire in floor that emits a field, for example, e-m low frequency field which is tracked by robotic chair 150. Multiple wires, each with different frequency, pulses sequences, etc. can be used. Optionally, a grid is employed. Optionally, the same wire(s) can be used to send instructions to robotic device 150. Optionally, the operating system 190 of clinic 100 informs Mr. Smith of a current destination, for example by having robotic device 150 speak to him. Optionally this maintains patient attention. In an exemplary embodiment of the invention, Mr. Smith's response to these instructions is monitored by system 190 used to assess cognitive function. Optionally, patient acknowledgment may be required. Optionally, robotic chair 150 may ask Mr. Smith questions about passing environmental stimuli via communication module 530 as a cognitive exercise. This permits therapy as a byproduct of many activities. Alternatively or additionally, therapy may be provided to fill available time. For example, if fitting for bands 320 takes fifteen minutes, the time might be used for presentation of speech therapy exercises. Because system 190 does not allocate resources based upon temporal units of a predetermined size, a 30 second wait for an elevator can be transformed into therapy time. Optionally, the operating system 190 of clinic 100 guides Mr. Smith to the current destination, by having robotic device 150 issue a series of verbal instructions. Regardless of the exact operational configuration employed, Mr. Smith may be assisted in navigating through clinic 100 by robotic chair 150 to the degree that he requires and may arrive at relevant destinations such as walking unit 230, full body treatment apparatus 600, daily activities rehabilitation room 280 or any of multi-purpose private rooms 220. Alternately or additionally, robotic chair 150 may guide Mr. Smith to consultations with human staff members of clinic 100 (e.g. doctor 140, nurse 145, PT 147 or OT 149). Alternatively or additionally, these human personnel may ascertain Mr. Smith's current location from the operating system 190 and go to him for observation/consultation.

In an exemplary embodiment of the invention, Mr. Smith may optionally participate in group therapy sessions either as part of an actual group or a virtual group. For example, several patients performing a simulated running exercise using exercise modules 350 might be grouped in a single treatment room. Their progress around a simulated racecourse might be presented on a video screen to simulate a race. This configuration may elicit greater patient compliance by creating a competitive atmosphere. Optionally patients may tease or cajole one another into superior performance. Optionally, system 190 handicaps the race to make the outcome closer, and/or provide encouragement to one or more patients 110 having difficulty with the exercise. Alternatively or additionally, “virtual” competitors may be added to the display while one or more patients exercise in front of the screen and see their images projected into the competition. Patients may see their actual images projected on the screen or may view themselves as alternative characters, for example animated images selected from a menu of character images. Output from each of exercise modules 350 may, for example, be relayed through communication modules 530 to operating system 190 which runs the race simulation on the video screen. Optionally, Mr. Smith's therapy exercises incorporate elements of his habitual recreational activities (e.g. bowling or bridge).

In an exemplary embodiment of the invention, Mr. Smith may be presented with bridge problems on a display screen as a cognitive exercise. Recurrent presentation of the same problems over time may allow assessment of his progress in regaining cognitive function. For example, Mr. Smith may initiate cognitive therapy in simulated bridge problems as a “beginner”, progress to “novice” and plateau at “intermediate”.

In an exemplary embodiment of the invention, the organization of clinic 100 may be inverted so that Mr. Smith remains in a single location and various robotic devices 150 and/or human staff are brought to him according to availability and the requirements of his treatment plan as analyzed by the operating system 190 of clinic 100 and/or medical staff. This may be useful, for example if Mr. Smith s confined to his bed or is self conscious of his condition and does not wish to be observed by other patients. Of course, Mr. Smith may need to move to a specific location within clinic 100 to use a non-portable resource, such as, for example, a swimming pool.

In an exemplary embodiment of the invention, robotic chair 150 is equipped with an interface 310 to external robotic therapy modules 350. Therapy module 350 in FIG. 3 may provide, for example range of motion exercises for Mr. Smith's left arm. Module 350 includes, for example, angular rotation mechanism 352, linear displacement mechanism 354, a complementary interface 356 capable of connection to interface 310 of chair 150 and a positioning unit 358 which allows module 350 to be positioned in a desired location relative to robotic chair 150. A hinge 359 permits changes in location of module 350 relative to chair 150. A second module 350 is pictured in FIG. 3 on the right side of patient 110. Mr. Smith will not require treatment on his (unaffected) right side, so the operating system 190 may optionally allocate him a single module 350. Optionally, Mr. Smith may be provided with two modules 350, one for his left arm and one for his left leg. The operating system 190 of clinic 100 treats modules 350 as resources and monitors their location and availability. In order to facilitate resource allocation, modules 350 optionally communicate with the operating system 190 through communication modules 350. Optionally, modules 350 may be transported through clinic 100 by human personnel to facilitate transfer from one patient 110 to another. These human personnel may, for example, assure quick and correct attachment of modules 350 to chair 150 and/or the floor. Alternatively or additionally, Mr. Smith employs two modules 350, one for his left arm and one for right arm so that his good arm can train his bad arm. Optionally, articulated robotic arms, for example of the type depicted in FIG. 4, may substitute for the ball and stick module 350. Regardless of the exact physical configuration of module 350, it may be capable of assisting patient 110 in performing range of motion exercises of a desired body part in accord with an individual therapy plan provided by operating system 190. Depending on the exact status of patient 110, exercises presented through module 350 may be either active or passive. Optionally, a patient that initially performs a specific exercise passively may later perform the same exercise actively. Optionally this transition from passive to active exercises is gradual, for example by incrementally reduced force supplied by module 350. Optionally, module 350 provides exact 3D positioning custom tailored to a specific patient 110 to increase therapy efficacy.

Module 350 is illustrated connected to attachment band 320A. The same module 350 may optionally be attached to any attachment band 320. Choice of attachment band 320 governs which body part is the subject of the specific therapy exercise. Optionally, band 320 may light up to facilitate quick connection. Because system 110 is configured to increase utilization of resources such as robots 150 and modules 350, connection time is important. Optional features such as click to fit connectors and/or illuminated connection points may help reduce connection time. In an exemplary embodiment of the invention, attachment of robotic chair 150 to exercise module 350 may be accomplished in less than 60 seconds, optionally less than 30 seconds, optionally less than 10 seconds, optionally less than 5 seconds. Mr. Smith may exercise all the affected portions of his left leg and left arm using the same module 350. Optionally, an attachment band 320 may be used to anchor a body part while a second body part is manipulated. For example, attachment band 320B might be anchored to armrest 308 while module 350 is attached to band 320A. Alternatively or additionally, an attachment band 320 may be anchored to a movable element for subsequent positioning, for example by a motor. Alternatively or additionally, the movable element may be illuminated when it is in the correct position. Manipulation of band 320A causes the left elbow to flex in this case. Switching of the attachment point of module 350 from one attachment band 320 to another may be accomplished either automatically by the operating system 190 or with the aid of human staff. Because Mr. Smith is recovering from a stroke, his physical therapy is primarily to assist him in reacquiring lost central nervous system function. To that end, the operating system 190 may optionally provide him with cues (e.g. audible instructions) and/or physical stimuli. The physical stimuli may be provided in the form of an applied force to a specific body part in a desired direction of motion. As central nervous system function improves, the amount of applied force is reduced, optionally incrementally. Optionally, the operating system 190 measures the amount of supplementary force in the desired direction supplied by Mr. Smith.

In an exemplary embodiment of the invention, a different patient 110 using a similar module 350 for a different reason might receive a resistive applied force in a similar exercise. This configuration may be useful, for example in a postoperative context or in treatment of a sports injury, when muscle strength rather than neuronal function is a primary issue.

The operating system 190 of clinic 100 may periodically offer Mr. Smith the chance to take a break. Optionally, these offers may be made if the operating system 190 perceives patient fatigue. Fatigue may be perceived, for example by monitoring physiologic data, for example data acquired through Mr. Smith's bracelet 530, or in response to performance data (e.g. failure to complete a series of repetitions of a specific exercise). Alternately, or additionally, Mr. Smith may request a break. Optionally, Mr. Smith remains in his robotic chair 150 during the break. Optionally chair 150 may guide Mr. Smith to a correct restroom 270. Optionally, module 350 assists Mr. Smith in the restroom, for example by applying support and/or force to attachment band 320C so that Mr. Smith may rise to a standing position using muscle strength on his right side. Although Mr. Smith perceives this as a non-therapy activity, it is a daily activity rehabilitation exercise 180 according to his treatment plan. Optionally, his insurance carrier is billed. Alternately, or additionally, Mr. Smith may choose to go to the cafeteria in robotic chair 150 during a break. Module 350 attached to band 320A may assist Mr. Smith in manipulating a fork held in his left hand as he cuts food with a knife held in his right hand. Again, although the patient perceives this as a non-therapy activity, it is a daily activity rehabilitation exercise 180 according to his treatment plan. Billing may occur.

Mr. Smith may optionally spend several hours in clinic 100, perhaps even a full day. The amount of time he spends with doctors, nurses and therapists is only a small portion of the total time at the clinic. Of the total time spent at the clinic, the amount of time spent waiting for available resources and/or personnel is low. Because many of Mr. Smith's activities are designed by operating system to have a therapeutic aspect in accord with his treatment plan, at least 60%, or a least 70%, or at least 80%, or at least 90% or virtually all of the time Mr. Smith spends in the clinic may be therapeutic.

Optionally, Mr. Smith goes home with robotic chair 150 or has a similar or alternately configured robotic device 150 at home. Communication modules 530, optionally in the form of a patient bracelet, serve to relay therapy instructions from operating system 190 and/or to gather patient performance data for relay to operating system 190. Optionally, Mr. Smith's bracelet 530 informs the operating system 190 of the clinic that he is leaving as he passes through an exit door. Optionally this permits daily activity rehabilitation 180 in Mr. Smith's home instead of in daily activity rehabilitation room 280 at the clinic. Optionally, Mr. Smith's insurance carrier is billed for use of robotic chair 150 and/or module(s) 350 which occurs outside clinic 100. In his home, Mr. Smith optionally navigates chair 150 from room to room. Optionally, a floor plan of Mr. Smith's house is provided to the operating system 190 and made accessible to robotic chair 150. Optionally a navigation system is installed in Mr. Smith's homes as described hereinabove for clinic 100. Optionally chair 150 responds to verbal cues from Mr. Smith. Optionally, chair 150 provides verbal cues to Mr. Smith if he becomes confused or disoriented. In an exemplary embodiment of the invention, Mr. Smith's navigation of robotic device 150 through his own home serves as a cognitive therapy exercise.

In an exemplary embodiment of the invention, a robot 150 may engage in a behavior designed to elicit a response from patient 110. The response may be part of an individual treatment plan and/or help a patient 110 feel useful and/or provide emotional support. Toys that need “care” are known and robot 150 can emulate them or toys can be modified and/or programmed to interface with operating system 190 for implementation of at least a portion of a treatment plan. For example, an android robot 150 may be sized as a baby and programmed to cry in order to elicit a response in which patient 110 picks up robot 150 and walks back and forth. Alternatively or additionally, a canine robot 150 may be programmed to bring a tennis ball and initiate a game of fetch.

Optionally, a game of fetch may be implemented by installing an RFID in the ball and a corresponding tracker in the mouth of canine robot 150. The robotic dog will then be programmed to home in on the signal with an RFID proximity sensor and pick up the ball with its mouth. Return to proximity of Mr. Smith may optionally be facilitated by an additional RFID on Mr. Smith (e.g. in his communication module bracelet 530). This encourages patient 110 to, for example, bend at the waist to pick up the ball from the floor and/or engage in shoulder rotation, elbow flexion and arm extension to throw the ball. Optionally, canine robot 150 may respond to being petted, for example by wagging a mechanical tail. Optionally, robots 150 may exhibit mixed traits. For example a canine robot may say “pick up the ball, we have work to do!” if barking does not produce a response. Optionally, pet robot 150 initiates therapeutic interactions with patient 110. Alternatively or additionally, patient 110 initiates therapeutic interactions with pet robot 150.

In an exemplary embodiment of the invention, a robot can critique the patient and to increase rehabilitation progress. This may be accomplished, for example, by analysis of patient performance by system 190 followed by formulation of a suggestion such as “Try not to turn your toes out as you lift your knee.” This suggestion may be delivered through communication module 530, optionally in the form of a spoken suggestion from an android robot 150. Alternately, or additionally, shorter local feedback loops may be employed to acquire patient performance data, analyze performance and provide constructive criticism. Optionally, patient 110 will feel that robot 150 is “watching”, although robot 150 has no eyes. Optionally, robot 150 is equipped with at least one CCD camera and actually “watches” patient 110 using the CCD camera as an eye.

Embodiments of this type may be useful, for example, in treating patients that live alone and/or patients that are subject to depression. Optionally, a patient 110 may be provided with a primary robotic device (e.g. a chair 150 of the type depicted in FIG. 3) and a secondary robotic device 150, such as a robot dog. The secondary robotic device 150 may functionally substitute for exercise module 350, for example by playing fetch.

In an exemplary embodiment of the invention, system 190 merely requires that patient 110 perform the exercises. This mode of operation may be employed, for example with a patient 110 that is only capable of passive compliance, such as Mr. Smith at the beginning of his treatment.

In an exemplary embodiment of the invention, system 190 may additionally require that patient 110 perform a specific exercise correctly. This mode of operation may be employed, for example with a patient 110 that is capable of active compliance, such as Mr. Smith in a more advanced stage of his treatment. Optionally, as a patient's ability with regard to a specific exercise increases, system 190 provides more criticism concerning performance of the task. This may increase progress towards treatment goals.

Design and implementation of an operating system requires adherence to a rehabilitation model. For example, a currently accepted rehabilitation model is to choose a desired level of performance with regard to a specific activity and to divide the activity into component parts. Goals are then designed to facilitate acquisition of a skill with regard to each of the component parts. Each goal is then assigned a time for completion. Exercises are then designed to reach each goal. A treatment plan is then designed to help the patient reach the goals in a timely fashion by performing the exercises. Because treatment plans are, to a large extent, modular, operating system 190 can be designed to analyze a patient diagnosis and formulate an initial treatment plan. Optionally, standard language may be employed by medical personnel in formulating a diagnosis to facilitate formulation of an initial treatment plan by system 190. Optionally, the initial treatment plan is subject to review by clinic staff prior to implementation. In an exemplary embodiment of the invention, the initial treatment plan is frequently reviewed in light of patient performance and a revised treatment plan is formulated. Optionally, this review is conducted by system 190 and/or human staff members of clinic 100.

Optionally, Mr. Smith travels home on public transportation in chair 150. Optionally Mr. Smith makes a detour through a park. Optionally, therapy continues en route, for example in the form of exercises implemented through exercise module 350. For example, angular rotation mechanism 352 may rotate towards and away from chair 150 causing Mr. Smith to repeatedly flex his left elbow. Alternatively or additionally, linear displacement mechanism 354 may extend and retract causing Mr. Smith to repeatedly raise and lower his left hand. Optionally billing may occur. Although Mr. Smith has not yet made any clinically significant progress at the end of his first day of therapy, he may enjoy an enhanced sense of well being and independence. In an exemplary embodiment of the invention, extension of therapy exercises beyond the walls of clinic 100 encourages patient compliance. Alternatively or additionally, a patient may attach greater importance to therapy performed in the context of daily activities. Optionally, a specific exercise may be repeated in clinic 100 and outdoors, with parameters adjusted so that the indoor version is easier in order to enhance a patient sense of accomplishment.

Optionally, chair 150 remains in contact with the operating system 190 of clinic 100. Optionally, chair 150 contacts the operating system 190 of clinic 100 periodically (e.g. through a cellular telephone network). Optionally a communication module 530 of chair 150 or Mr. Smith's bracelet 530 is equipped with a GPS device so that operating system 190 remains aware of Mr. Smith's location even when he is out of clinic 100. Optionally, robot 150 may help Mr. Smith navigate outdoors, for example by issuing verbal cues to guide him to a selected destination such as, for example his home or workplace. In an exemplary embodiment of the invention, robot 150 is equipped with a CCD camera and relays pictures/video of Mr. Smith or the surroundings to system 100 for use in therapy and/or diagnostics. Utility may be, for example in criticism of body motion, design of new exercises, revision of a therapy plan, or as a basis for cognitive exercises of “Who did we meet by this statue?” or “Which bus goes to this park?” In an exemplary embodiment of the invention, GPS data aids in resource allocation as the operating system 190 detects patients traveling towards clinic 100. Optionally this permits patients to “drop-in” without making an appointment.

In an exemplary embodiment of the invention, robotic device 150 may be configured as an articulated chair (FIG. 4). Optionally, attachment bands 320A and 320B are provided as part of articulated chair 150. The functionality of replacement module 350 is achieved by a plurality of articulation points 430. Optionally these points 430 are hinges with a single rotational axis. Optionally, footrests 410 are provided for leg extension exercises. Optionally these points 430 are joints with multiple rotational axes. Articulation points 430 are optionally flexed in a coordinated fashion to cause a selected joint of subject 110 seated in chair 150 to move in a desired fashion. Optionally, sensors 420 measure a response of subject 110 in terms of displacement and/or weight distribution. As with treatment module 350, the exact workings of articulated chair 150 may differ according to an individual treatment plan of patient 110. Optionally, robot 150 may be configured as a bed, for example an articulated bed. Alternately, or additionally, exercise modules 350 may be attachable to a bed. Articulation permits manipulation of selected joints through a programmed range of motion. In immobile patients, a programmed series of articulations may reduce the incidence of pressure sores. Even in patients with willful mobility, periodic implementation of a programmed series of articulations may improve circulation. Optionally, Mr. Smith may have an articulated chair 150 of this type installed at home where it may function as his “command” chair.

Typically, when Mr. Smith begins treatment, he is non ambulatory. One of his long term treatment goals is to recover normal ambulatory function. Independence is an intermediate stage in pursuit of this goal. Independence requires a desire for motility, ability for motility and ability to navigate. In an exemplary embodiment of the invention, robotic chair 150 stimulates the desire for motility, provides supplementary motility abilities and aids in navigation. This permits Mr. Smith to perceive the benefits of his long term goal well before he actually achieves it. This may induce increased treatment compliance.

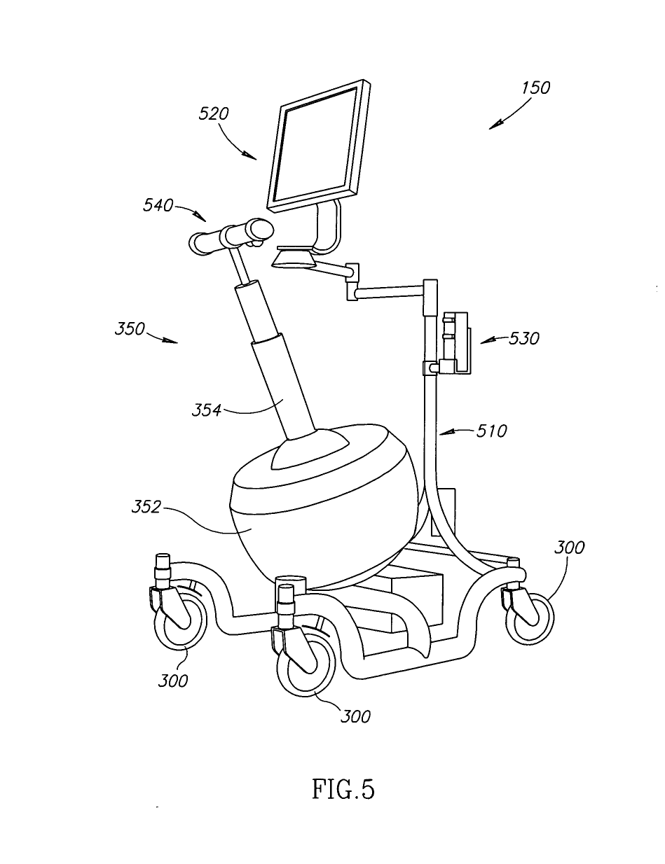

At some point in therapy, Mr. Smith no longer requires robotic chair 150, but is not yet ready to walk independently. At this point, he may surrender robotic chair 150, for example at reception area 220 and receive a robotic guide cart 150 (FIG. 5). Mr. Smith's chair is optionally reassigned to another patient by the operating system 190 of clinic 100. Optionally this occurs with only a brief delay, for example less than 5 minutes. The equipment exchange may optionally be initiated by the operating system 190 or by Mr. Smith. When Mr. Smith is prepared to return to work, he may optionally continue to use robotic cart 150 in the workplace until it is no longer required. Optionally, Mr. Smith may continue to use robotic cart 150 indefinitely in the same way that a cane has traditionally been employed to increase mobility and/or provide a sense of security.

In an exemplary embodiment of the invention, reassignment of Mr. Smith's chair 150 includes consideration of patient dimensions. Optionally, chairs come in a range of predetermined sizes and are assigned to patients with corresponding dimensions. Optionally, chairs 150 have adjustable dimension (e.g. seat height and seat width) and are reconfigured for each recipient. Optionally adjustments are made automatically by system 190. Optionally, adjustments are made by hand. In an exemplary embodiment of the invention, reconfiguration requires less than one minute.

Robotic guide cart 150 may include, for example, wheels 300 and frame 510. Frame 510 serves to transfer a directive force applied by patient 110 to wheels 300. Wheels 300 permit directive forces applied by patient 110 to cause motion of cart 150 with reduced friction. Optionally, wheels 300 are motorized. Optionally a drive mechanism of wheels 300 slightly amplifies force applied to the cart through handlebars 540. For example, Mr. Smith applies sufficient force to handlebars 540 to cause cart 150 to roll one meter forward, a supplementary propulsion mechanism (e.g. motor) may cause cart 150 to roll an additional meter. In an exemplary embodiment of the invention, supplementary propulsion mechanism does not cause acceleration. Optionally, cart 150 is equipped with an internal exercise module 350 including angular rotation mechanism 352 and linear displacement mechanism 354. This arrangement permits cart 150 to require Mr. Smith to bend from the waist, stand erect, lean to one side or the other, and generally alter his posture. These exercises optionally increase Mr. Smith's overall body perception and/or improve his sense of balance. Optionally, these exercises are used to increase muscle tone, muscle strength and or range of motion. Optionally, cart 150 may be programmed to apply a slight resistive force through wheels 300 in order to simulate uphill conditions as a means of increasing muscle strength and/or cardiovascular function. This may be accomplished, for example, through supplementary propulsion mechanism operated in a “reverse” mode. Optionally, cart 150 is equipped with sensors which measure patient posture and/or speed and/or acceleration. Optionally, cart 150 presents cognitive exercises to Mr. Smith on display screen 520 and/or through a speaker of communication module 530. Communication module 530 optionally receives verbal response from Mr. Smith through a microphone. Alternately or additionally, Mr. Smith may provide responses through an input device, for example using optional touch-screen features of display screen 520. Display screen 520 may optionally be employed to deliver entertainment content during therapy breaks. This entertainment content may optionally include video games. These video games may optionally be configured to help Mr. Smith progress towards one or more goals in his therapy plan. Optionally, time spent playing a specially configured game is reported to the operating system 190 as a therapy session. Optionally billing may occur, possibly at a lower rate.

The transition from chair 150 to cart 150 is indicative of Mr. Smith's progress in motor rehabilitation. At this stage, the emphasis of his treatment plan may optionally shift to cognition exercises and/or speech therapy and/or aphasia intervention. Communication module 530 may also receive instructions from the operating system 190 of clinic 100 and/or relay Mr. Smith's performance data to the operation system for inclusion in his patient record. Optionally Mr. Smith's treatment plan is revised as a result. Optionally, Mr. Smith may issue requests through communication module 530, for example he may ask to consult with a therapist. In an exemplary embodiment of the invention, cart 150 reduces, the frequency with which Mr. Smith visits clinic 100 because it takes the place of resources typically found in a conventional clinic.

The waiting room in clinic 100 may include game stations programmed for cognitive exercises and/or to measure and/or respond in a personalized manner to patients. Standard waiting areas typically do not include measurement and data collection interfaces.

Optionally, communication module 530 is generic and inexpensive (e.g. a cellular telephone, walkie-talkie or PDA). In an exemplary embodiment of the invention, a patient 110 uses his own cellular telephone or PDA as a communication module 530. Communication module 530 serves to update clinic 100 with regard to resource availability/location and/or patient performance/location. Each of communication modules 530 communicating with system 190 is optionally assigned to a specific patient, staff member, or physical resource (e.g. robot 150; room or therapy machine). Communication module 530 reports its location to the operating system 190 which optionally responds by directing patients and/or staff to a specified location.

In an exemplary embodiment of the invention, communication module 530, e.g. in the form of a bracelet monitors and reports patient status. Optionally, module 530 may detect and report situations which require immediate medical intervention, such as, for example a heart attack or seizure. Optionally, communication module 530 includes a GPS locator. Optionally, communication module 530 is capable of interface with a cellular telephone network, a wireless network, a radio frequency receiver or an infrared communication port.

Optionally, communication module 530 is employed to make and/or cancel appointments. Optionally, reminders may be issued to patients through communication module 530. In an exemplary embodiment of the invention, communication module 530 can be employed to arrange patient transportation to and from clinic 100. For example Mr. Smith may issue a request for patient transport in response to an appointment reminder delivered to him via bracelet 530. System 190 checks available transportation resources and instructs a van with an available wheelchair bay to stop at Mr. Smith's house. System 190 then sends a message to Mr. Smith with an estimated pick up-time.

In an exemplary embodiment of the invention, communication module 530 is associated with a specific piece of equipment or room and indicates availability and/or location of the resource. Optionally, communication module 530 can detect and report equipment malfunction. For example, module 530 may have an interface to a controller of a robot 150 or therapy device. The controller includes a monitoring module which detects any deviation from defined operating parameters. These deviations are optionally routed to system 190 through module 530. Appropriate human or robotic maintenance resources may then be dispatched to diagnose and/or repair the problem.

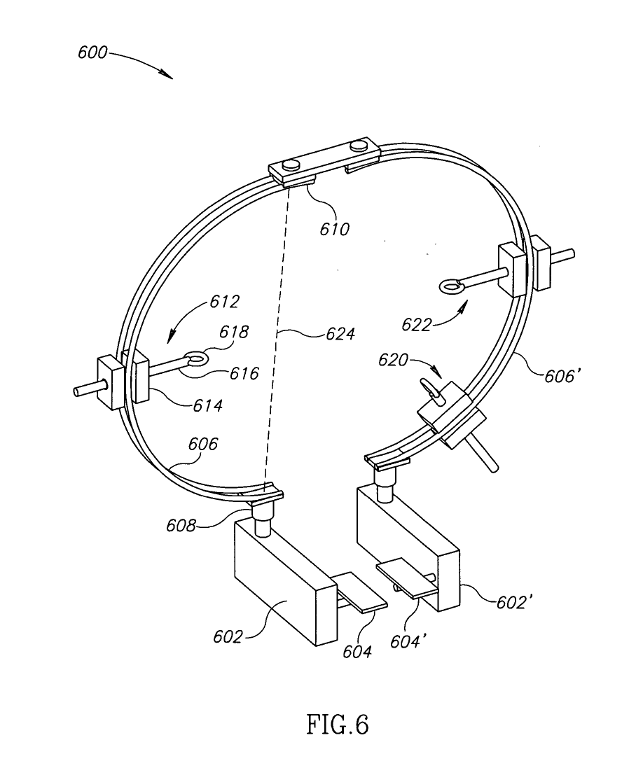

Mr. Smith's therapy plan may include some exercises designed to develop coordinated movement of upper and lower body parts. Optionally, this may be accomplished by use of multiple modules 350 as detailed hereinabove. Alternately, or additionally, an exercise device 600 in accordance with an exemplary embodiment of the invention (FIG. 6) may be employed, for example a full body treatment device located in daily activity room 280 or private room 235. According to this embodiment of the invention, optional lower limb training section includes a base 602 having a pedal 604 mounted thereon. Optionally, pedal 604 is capable of rotary motion relative to a horizontal axis (e.g., as in a bicycle) alternatively or additionally to rotation around its axis. As shown, two base sections 602 and 602′ (with a pedal 604′) are shown. A chair, for example, Mr., Smith's robotic chair 150 is optionally placed between the base sections. An optional upper limb section comprises at least one arcuate element 606 on which at least one limb unit 612 is attached. Arcuate element 606 is optionally hinged so that it can rotate around an axis 624. A first hinge 608 attaches arcuate element 606 to base 602. A second hinge 610 may be used to couple arcuate element 606 to its mirror element 606′. Limb unit 612 optionally includes a base section 614 capable of manual, motorized and/or resistance to motion along arcuate element 606. A handle 616 optionally telescopes from base section 614 and includes an optional grip 618 at its end. Optionally, the grip is exchangeable. One or more limb units 620 and 622 may be provided on arcuate element 606′. Optionally an additional arm support may be used to balance patient hand. (e.g. an articulated arm support or a sling from above attached to the frame) In some embodiments of device 600, only a subset of these features are provided.

In use, a patient is positioned in device 600, between base sections 602 and 602′ and holds onto grips 618. Optionally, attachment bands 320 may substitute for active gripping. Rotation of arcuate sections 606 in combination with telescoping motion of handle 616 can be used to achieve any spatial position of grip 618. Rotation of handle 616 is also possible. Actuators (not shown) and sensors (not shown) may be employed to monitor patient performance in the form of, for example, pressure and/or speed and/or force and/or tension. Alternatively or additionally cameras may be employed to acquire video images for analysis.

For storage, arcuate elements 606 and 606′ may fold to be over base sections 602 and 602′, such as around axis 624 shown for the left arm.

Device 600 is optionally used to teach gait, for example, teach the correct motion of feet and arms together. Articulated arms for engaging the thigh and/or knee may be provided as well. In order to encourage Mr. Smith to progress in treatment, device 600, or four exercise modules 350, may optionally be configured to simulate the windup and release of a bowling ball. Once Mr. Smith can stand, the accompanying steps towards the foul line might be incorporated into the exercise. Optionally, Mr. Smith holds a light weight bowling ball and optionally including sensors linked to device 600 and/or system 190. Optionally, Mr. Smith might receive feedback in the form of a video simulation of a bowling ball rolling down a bowling alley towards a set of bowling pins. This feedback is actually criticism of performance, but the delivery method makes Mr. Smith want to comply with treatment. Similar technology may be implemented in the context of other sports or recreational activities according to personal preferences of patient 110.

In an alternative embodiment, base sections 602 and 602′ comprise arcuate elements as well, for example, elements lying on the floor or vertical elements, for example perpendicular to elements 606. Leg attachments or pedals may be provided instead of grips 618.

In an exemplary embodiment of the invention, clinic 100 employs an operating system 190 including clinic management software. The clinic management software tracks available resources in terms of availability and location. Tracked resources include human resources and equipment resources. Human resources may include, for example, one or more of medical personnel (e.g. doctors, psychologists and nurses), therapists (e.g. OT, PT and speech therapists), orderlies and incidental staff (e.g. maintenance workers, cleaners, kitchen personnel). Equipment resources include, for example, robotic devices 150, modules 350 and full body machines 600, VR setups and other portable and/or fixed equipment. In addition, the software 101 tracks various types of rooms such as, for example walking units 230, full body rooms 260, activities of daily life rooms 280 and private rooms 235. Additional equipment such as, for example, therapy balls, computer stations and weight machines may also be tracked by the software. Optionally, a room may be defined by a single piece of equipment located therein for tracking purposes. For example, a small room housing a universal weight machine permanently mounted to the floor might optionally be inventoried by system 190 as a single resource because “If the machine is in use, the room is unavailable.” Conversely, “If the room is unavailable, the machine is in use.” This approach might be advantageously employed, for example, with individual hydrotherapy units, each unit occupying a cubicle.

Optionally, the clinic management software 101 operates in conjunction with a database of patient information. The database may include, for example, a diagnosis, treatment plan, unique identifier and billing arrangements for each patient. Optionally the database includes an in/out designation for each patient to indicate whether they are on the premises of clinic 100. Optionally, the data base includes an absolute patient location acquired from a GPS device carried by the patient. Optionally the software handles scheduling of patient appointments. Optionally, clinic 100 operates on a drop-in basis. Optionally, the software may invite patients to come in on short notice if important tracked resources are underutilized, for example if anticipated utilization falls below 80%, optionally below 70% optionally below 60% of possible utilization. Optionally, the software may cancel patient appointments on short notice if current demand exceeds current available resources. In an exemplary embodiment of the invention, system 190 distributes cancellation among different patient types. Optionally, billing refunds or credits may be applied to accounts as a result of cancellations initiated by system 190. Alternatively or additionally, system 190 refers a patient 110 to an alternate clinic 100 and relays patient data to that alternate clinic. In an exemplary embodiment of the invention, two or more of clinics 100 operate as a network and share a patient database. Alternatively or additionally, patients may be transferred from one clinic to another to gain access to unique resources and or to pursue treatment goals not found in the clinic where they began therapy.

Optionally the software provides medical personnel and therapists a flexible interface to assess individual patient progress and/or general efficiency of treatment in clinic 100. Optionally, reports may be generated by patient type, e.g. stroke rehabilitation, post-operative rehabilitation and sports related injury rehabilitation. Optionally, reports on an individual patient may be generated in terms of general progress towards defined treatment objectives and or performance of specific treatment exercises. Optionally, medical personnel and/or therapists may update a patient's treatment plan based upon review of a report and/or consultation with a patient. Alternately, or additionally, the software may suggest changes in treatment plan based upon analysis of performance of a first patient relative to performance of one or more other patients with a similar diagnosis.

In an exemplary embodiment of the invention, software 101 optionally keeps track of all services provided to each specific patient and bills the appropriate entity (e.g. private insurance company or governmental agency). Billing may be, for example, immediate, daily, weekly or monthly.

In an exemplary embodiment of the invention, a patient 110 is assigned a personal robot 150 to administer their treatment plan. Optionally, robot 150 is an android. Alternatively or additionally, robot 150 is a robotic chair 150 as detailed hereinabove. Optionally, robotic chair 150 may have android features, for example a credible human voice.

In an exemplary embodiment of the invention, each of patients 110 receives a personal kit including a patient ID (e.g. bracelet 530), an individual therapy program and an initial diagnostic evaluation. As treatment proceeds, additional progress reports and evaluations may be added to the kit. Assignment of resources (e.g. specific robot configuration 150 and/or modules 350) to individual patient 110 is in view of the patient's individual treatment plan and their progress towards treatment goals. The software may change resource allocations based upon patient progress and/or resource availability. Optionally, treatment provided by clinic 100 may be in one or more treatment modes:

A) Clinic based therapy-Patients come to clinic 100 to receive service in the form of staff consultation and/or access to equipment (e.g. robots 150);

B) In-situ therapy—Patients perform therapy exercises in their natural environment (e.g. home and/or workplace);

C) Daily Activities Rehabilitation—Patients perform therapy exercises while engaged in a routine activity (e.g. walking, getting dressed, eating or playing a game).

D) Assistive therapy—A robotic device 150 and/or module(s) 350 guide the patient towards a desired performance.

E) Disruptive therapy—A robotic device 150 and/or module(s) 350 prevent the patient from deviating from a desired performance.

In an exemplary embodiment of the invention, a patient 110 is scheduled for an extended appointment in clinic 100 on a single day, for example 6 hours. Optionally, this time is divided into treatment sessions, with each session designed to encourage progress towards one or more goals in the patient's individual treatment plan. Each treatment session may be short, for example 10 minutes. Optionally the patient is aware of the transition from one treatment session to another. Optionally the patient does not perceive a treatment session (e.g. fine motor co-ordination exercises for the hand administered during a “meal break”). This approach may reduce patient fatigue and/or boredom. It may also increase flexibility in allocation resources among patients as they become available. Alternately or additionally, this arrangement permits a patient to do all of their therapy on a single day, reducing travel time to and from the clinic and reducing absenteeism from work. Some patients that are in an advanced stage of rehabilitation may continue to visit clinic 100 for shorter appointments to achieve one or two remaining treatment goals. For example, a patient might come in once a week for a half hour appointment including five six minute treatment sessions.

In an exemplary embodiment of the invention, idle time of patients and/or clinic resources is reduced by delivery of therapy in small temporal units which may be provided on short notice. Alternatively or additionally, the length of a “session” is variable allowing greater flexibility in temporal allocation of resources. For example, two patients can share one machine even if one patient works for 4 minutes and rests for 6 minutes cycle and the other works for 5 minutes and rests for 4 minutes cycle. System 190 will optionally provide alternate activities for the patients so that they do not perceive waiting. In an exemplary embodiment of the invention, efficient utilization of clinic resources is weighed against efficient implementation of an individual patient therapy plan.

Communication module 530 may optionally be used to transmit audio and/or visual data. Transmission may be from patient 110 to the operating system 190 and/or from the operating system 190 to patient 110. In an exemplary embodiment of the invention, the operating system 190 receives video images of patient 110 performing therapy exercises with robot 150 and/or module 350. Alternatively or additionally, operating system 190 receives video images of patient 110 performing daily activities without robot 150 and/or module 350. Optionally attachment bands 320 are equipped with targets that can be extracted from video sequences for computerized analysis of motion patterns (e.g. gait analysis). Optionally, patient 110 may transmit voice messages to the operating system 190. Alternately, or additionally, the operating system 190 may provide audio and/or visual data to patient 110. This may include, for example, a graph of progress towards a treatment goal displayed on display screen 520. Alternately or additionally, robot 150 may offer verbal encouragement to elicit improved patient performance. Alternately or additionally, robot 150 may issue reminders to encourage adherence to a schedule, for example a medication schedule. Alternatively or additionally, Robot 150 may dispense medication according to a schedule from an optional dispenser module (not shown).

Optionally, the operating system 190 corrects the treatment plan according to orders issued by doctors. Optionally, the operating system 190 may receive input from people not employed by clinic 100 (e.g. Mrs. Smith may input progress reports on Mr. Smith) and issue suggested corrections of the treatment plan for review by doctors or other staff members. Optionally, the operating system 190 interacts with one or more monitoring systems installed outside the clinic, for example in a patient's home or office. Monitoring systems may include, but are not limited to GPS devices and/or video cameras as described hereinabove.

Optionally, the operating system 190 provides information and or support to family members and/or caretakers of patients 110. Information may be provided, for example, by e-mail or fax transmissions executed by the operating system 190. Support may include consultation with a social workers and/or psychologist.

In an exemplary embodiment of the invention, operating system 190 of clinic 100 increases the efficiency with which clinic resources are utilized. Alternatively or additionally, the operating system 190 of clinic 100 increases the percentage of billable time for each visit to clinic 100. Optionally, an insurance carrier is billed for 70%, optionally 80%, optionally 90% or more of time that patient 110 spends in clinic 100.

Function of clinic 100 may rely upon execution of various commands and analysis and translation of various data inputs. Any of these commands, analyses or translations may be accomplished by software, hardware or firmware according to various alternative embodiments. In an exemplary embodiment of the invention, machine readable media contains instructions for clinic operation based upon input parameters described hereinabove.

In an exemplary embodiment of the invention, clinic 100 still relies heavily on human professional staff. Optionally, clinic 100 employs robotic carts to shuttle patients between treatment rooms for consultations with therapists in different disciplines. Optionally, patients perform cognition therapy in the form of navigation training between appointments. This achieves a decrease in idle time for patients relative to a conventional clinic.

In an exemplary embodiment of the invention, a take home robot 150 may be used to encourage patient compliance with exercises learned during a conventional PT session with a human therapist. The therapist may use the conventional one hour session to explain and demonstrate a series of exercises from the treatment plan using exercise module(s) 350.

Alternatively or additionally, multiple robotic devices 150 are deployed in a therapy gymnasium and patients are assisted in their use by skilled therapists. Optionally, multiple patients 110 are queued. Optionally, indicators (e.g. lights) on wheel chairs and/or devices 120 and/or modules 350 and/or machines 600 indicate which patients should be placed in which exercise resources. Optionally human attendants facilitate patient transfer and/or connection.

The present application can use the methods and apparatus described in the following applications, the disclosures of which are incorporated herein by reference:

| Title | Serial # | Filing Date | Exemplary contents |
|---|---|---|---|
| Methods and | PCT/IL2005/000142 | 02/04/2005 | Describes various methods and |
| Apparatus for | | | apparatus for rehabilitation, including |
| Rehabilitation | | | manipulators and methods of taking |
| and Training | | | motivation into account. |
| Methods and | PCT/IL2005/000136 | 02/04/2005 | Describes method and apparatus for |
| Apparatuses | | | rehabilitating while sitting and/or |
| for | | | rehabilitating balance and coordinated |
| Rehabilitation | | | movements. |
| Exercise and | | | |
| Training | | | |
| Gait | PCT/IL2005/000138 | 02/04/2005 | Describes method and apparatus for |
| Rehabilitation | | | rehabilitating gait and other multi-joint |
| Methods and | | | and/or coordinated movements. |
| A aratuses | | | |
| Rehabilitation | PCT/IL2005/000137 | 02/04/2005 | Describes using music as feedback and |
| with Music | | | for guiding rehabilitation. |
| Neuromuscular | PCT/IL2005/000135 | 02/04/2005 | Describes using sEMG and FES as part |
| Stimulation | | | of a rehabilitation process. |
| Fine Motor | PCT/IL2005/000139 | 02/04/2005 | Describes devices and methods for |
| Control | | | rehabilitating fine motor control, such |
| Rehabilitation | | | as writing. |
| Neuromuscular | PCT/IL2005/000442 | 4/28/2005 | Describes methods and apparatus for |
| Stimulation | | | rehabilitating using implanted wireless |
| | | | electrodes. |
| Motor | 60/686,991 | 06/02/2005 | Describes methods and apparatus that |
| Training with | And PCT | 02/18/2005 | relate to rehabilitation while monitoring |
| Brain | application Ser. No. | | a brain |
| Plasticity | PCT/IL2005/000906 | | |
| Device and | 60/665,886 | 03/28/2005 | Describes rehabilitation and/or support |
| Method for | | | devices suitable for persons of limited |
| Training, | | | mobility |
| Rehabilitation | | | |
| and/or Support | | | |
| Apparatuses | 60/666,136 | 03/29/2005 | Describes retrofitting exercise device |
| for Retrofitting | | | for use in rehabilitation |
| Exercise | | | |
| Equipment and | | | |
| Methods for | | | |
| Using Same | | | |
| Methods and | U.S. application | 02/18/2005 | Describes methods and apparatus for |
| Apparatuses | Pat. No. 11/207,655 | | rehabilitation |
| for | | | |
| Rehabilitation | | | |
| and Training | | | |

In the description and claims of the present application, each of the verbs “comprise”, “include” and “have” as well as any conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to necessarily limit the scope of the invention. The described embodiments comprise different features, not all of which are required in all embodiments of the invention. Some embodiments of the invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A computerized clinic management system, the system comprising:
(a) a database of patient records;
(b) a database of clinic resources reflecting a temporal availability of each individual resource in said database of clinic resources; and
(c) a scheduling module, said scheduling module configured to determine an initial subset of said clinic resources required for an initial treatment plan for a patient based upon analysis of said database of patient records and to determine an initial schedule of therapy for said patient based upon further analysis of said temporal availability of said subset of said clinic resources.

2. The system of claim 1, further comprising a plurality of communication modules, each individual module of said plurality of communication modules assigned to a specific clinic resource and configured to apprise said database of clinic resources regarding an actual availability status of said specific clinic resource.

3. The system of claim 1, further comprising a plurality of communication modules, each individual module of said plurality of communication modules assigned to a specific clinic resource and configured to apprise said database of clinic resources regarding a location of said specific clinic resource.

4. The system of claim 1, further comprising a plurality of communication modules, each individual module of said plurality of communication modules assigned to a specific patient and designed and configured to apprise said database of patient records regarding an occupation status of said specific patient.

5. The system of claim 1, further comprising a plurality of communication modules, each individual module of said plurality of communication modules assigned to a specific patient and configured to apprise said database of patient records regarding a location of said specific patient.

6. The system of claim 1, further comprising a plurality of communication modules, each individual module of said plurality of communication modules assigned to a specific patient and configured to apprise said database of patient records regarding a performance statistic of said specific patient with regard to at least a portion of said treatment plan.

7. The system of claim 1, wherein at least a portion of said clinic resources include a programmable robotic component.

8. The system of claim 1, additionally comprising a billing module, said billing module configured to detect use of said subset of said clinic resources by a patient and to issue a bill according to a billing designation in said database of patient records.

9. The system of claim 1, additionally comprising a plurality of communication modules, each of said communication modules associated with a clinic resource and configured to report at least an availability status of said clinic resource to said database of clinic resources.

10. The system of claim 9, wherein at least some of said communication modules are additionally configured to report a patient performance statistic to said database of patient records.

11. The system of claim 10, additionally comprising a diagnostic module, said diagnostic module configured to suggest changes in said initial treatment plan based upon said patient performance statistic to produce a revised treatment plan.

12. The system of claim 11, wherein said system allows said revised treatment plan to be subject to review by a human prior to implementation thereof.

13. The system of claim 12, wherein said system uses said revised treatment plan and said scheduling module to determine a revised subset of said clinic resources and to determine a revised schedule of therapy.

14. A modular therapy clinic, the clinic comprising:
(a) a plurality of multipurpose locations; and
(b) a plurality of portable therapy devices;
(c) a scheduling module, said scheduling module configured to determine a schedule of therapy device placement based upon anticipated need.

15. The clinic of claim 14, additionally comprising at least one non-portable therapy device located in at least one of said locations.

16. A method for calculating a fee for a rehabilitation service, the method comprising:
(a) receiving a data input indicative of a number of temporal units during which a patient was engaged in interaction with a therapeutic device;
(b) multiplying said number of temporal units by a billing rate of said therapeutic device to produce the calculated fee as a product.

17. A method for calculating a fee for a rehabilitation service, the method comprising:
(a) receiving a data input indicative of a number of connection events during which a patient was connected to a therapeutic device;
(b) multiplying said number of connection events by a billing rate of said therapeutic device to produce the calculated fee as a product.

18. A method of cognitive rehabilitation therapy, the method comprising:
(a) permitting a patient to navigate a path from an origin to a destination in an environment; and
(b) employing a computerized system to track said patient's position and compare said patient's position to said path and generate a comparison indicator.

19. The method of claim 18, additionally comprising:
(c) further employing said computerized system to provide at least one correction cue if said comparison indicator exceeds a defined limit.

20. The method of claim 18, additionally comprising providing a set of navigation instructions to said patient.

21. The method of claim 18, additionally comprising regulating a navigational parameter of said patient.

22. The method of claim 18, wherein said patient navigates a device along said path.

23. The method of claim 18, wherein said patient rides on said device.

24. A computer controlled cognition therapy device, the device comprising
(a) a navigable cart; and
(b) a computerized navigation component operative to track said cart's position and compare said cart's position to a target path and generate a comparison indicator.

25. The device of claim 24, additionally comprising a cue provision module operative to provide at least one correction cue if said comparison indicator exceeds a defined limit.

26. The device of claim 24, additionally comprising an instruction module operative to provide a set of navigation instructions to an operator of the device.

27. The device of claim 24, additionally comprising a regulatory mechanism operable to regulate a navigational parameter of said cart.

28. The device of claim 24, wherein said device is configured so that an operator of said cart may ride said cart.

29. A method of increasing efficiency of rehabilitation of a plurality of patients, the method comprising:
(a) providing a plurality of resources, each of said resources capable of communication with a computerized controller for purposes of informing said controller of an actual availability status;
(b) said computerized controller assigning each individual patient belonging to the plurality of patients to at least one of said resources based upon said actual availability status without regard to a fixed time schedule.

30. The method of claim 29, wherein said assigning comprises assigning with consideration of an individual therapy plan for each individual patient belonging to the plurality of patients.
